(19) United States
(12) Patent Application Publication
(10) Pub. No.: US 2017/0322286 A1
(43) Pub. Date: Nov. 9, 2017

(54) POSITIONING SYSTEM AND PROGRAM

(71) Applicants: Fumio YOSHIZAWA, Kanagawa (JP); Takeo TSUKAMOTO, Kanagawa (JP); Keisuke KONISHI, Kanagawa (JP); Yusuke MATSUSHITA, Kanagawa (JP); Takanori INADOME, Kanagawa (JP); Kenji KAMEYAMA, Kanagawa (JP); Katsuya YAMAMOTO, Kanagawa (JP); Yukio FUJIWARA, Kanagawa (JP); Hideaki ARATANI, Kanagawa (JP); Ryohsuke KAMIMURA, Kanagawa (JP); Hiroto HIGUCHI, Kanagawa (JP); Daisuke HATA, Saitama (JP); Juuta KON, Tokyo (JP); Tomoyo NARITA, Tokyo (JP)

(72) Inventors: Fumio YOSHIZAWA, Kanagawa (JP); Takeo TSUKAMOTO, Kanagawa (JP); Keisuke KONISHI, Kanagawa (JP); Yusuke MATSUSHITA, Kanagawa (JP); Takanori INADOME, Kanagawa (JP); Kenji KAMEYAMA, Kanagawa (JP); Katsuya YAMAMOTO, Kanagawa (JP); Yukio FUJIWARA, Kanagawa (JP); Hideaki ARATANI, Kanagawa (JP); Ryohsuke KAMIMURA, Kanagawa (JP); Hiroto HIGUCHI, Kanagawa (JP); Daisuke HATA, Saitama (JP); Juuta KON, Tokyo (JP); Tomoyo NARITA, Tokyo (JP)

(73) Assignee: Ricoh Company, Ltd., Tokyo (JP)

(21) Appl. No.: 15/101,021

(22) PCT Filed: Nov. 18, 2014
(86) PCT No.: PCT/JP2014/080992

§ 371 Date: Jun. 2, 2016

(30) Foreign Application Priority Data
Dec. 24, 2013 (JP) 2013-265735

(51) Int. Cl. G01S 5/02; G01S 1/04

(52) U.S. Cl. CPC G01S 5/0284; G01S 5/0247; G01S 1/042; G01S 1/045

(57) ABSTRACT

A positioning system includes a plurality of beacon modules and a communication device. Further, the communication device includes a calculation unit calculating action state data that are used for determining an action state of a user who carries the communication device; a searching unit selectively searching for one of the beacon modules in accordance with the action state of the user, the action state being determined based on the action state data calculated by the calculation unit, and a derivation unit deriving positional information of the user based on a response signal transmitted from the one of the beacon modules having been searched for by the searching unit.

### TECHNICAL FIELD

The present invention relates to a positioning system and a program.

### BACKGROUND ART

Conventionally, there has been widely used a communication apparatus such as a car navigation device, a smartphone, etc., as a device for providing a positional information service by using a Global Positioning System (GPS).

However, the GPS uses its satellite radio waves. Therefore, it is difficult for a device using the GPS to provide the positional information service in an area where the radio waves transmission is difficult.

On the other hand, as a device to resolve the problem, for example, Patent Documents 1 and 2 propose a communication device which receives a signal from a beacon module installed indoors, the signal including the installation position (location) of the beacon module, the beacon module providing communications using Bluetooth (registered trademark), so as to derive the positional information of the user of the communication device.

FIG. 13 schematically illustrates a configuration capable of deriving the positional information of the user based on the communication with the beacon module. As schematically illustrated in FIG. 13, when a user having a communication device passes through the installation position of a beacon module, a signal including the information of the installation position of the beacon module (i.e., in the example of FIG. 13, the coordinates (X,Y)=(47,63) or (67,43)) is transmitted to the communication device. Based on the information, it becomes possible for the communication device to derive the positional information indicating the current position of the user.

### SUMMARY OF THE INVENTION

### Problems to be Solved by the Invention

However, generally, a signal transmitted from a beacon module travels while repeating reflection and interference indoors. Due to the characteristic features, the accessible range of the signal may vary depending on the installation position of the beacon modules and also depending on time even when the installation position of the beacon module is not changed.

FIG. 14 schematically illustrates actual accessible ranges of the signals transmitted from the indoor beacon modules. As illustrated in FIG. 14, the boundaries between the actual accessible ranges of the beacon modules adjacent to each, other are uncertain (indecisive), so that there may be a limit of the accuracy of the positional information derived by the communication device based on the received signals.

Due to the limitation, it is desired to further improve the accuracy when the positional information is derived based on the communications with the beacon modules installed indoors.

The present invention is made in light of the problem, and an object of the present invention is to improve the accuracy of the positional information derived based on the communications with the beacon modules.

### Means for Solving the Problems

According to an aspect of the present invention, a positioning system includes a plurality of beacon modules and a communication device. Further, the communication device includes a calculation unit calculating action state data that are used for determining an action state of a user who carries the communication device, a searching unit selectively searching for one of the beacon modules in accordance with the action state of the user, the action state being determined based on the action state data calculated by the calculation unit, and a derivation unit deriving positional information of the user based on a response signal transmitted from the one of the beacon modules having been searched for by the searching unit.

### Effects of the Present Invention

According to an aspect of the present invention, it may become possible to improve the accuracy of the positional information derived based on the communications with the beacon modules.

### BRIEF DESCRIPTION OF THE DRAWINGS

FIG. 1 is a drawing illustrating a configuration of a positioning system according to an embodiment;

FIG. 2 is a drawing illustrating a hardware configuration of a mobile terminal included in the positioning system;

FIG. 3A is a drawing illustrating a state where the mobile terminal is worn on a user;

FIGS. 3B and 3C are drawings illustrating directions of the sensors of the mobile terminal;

FIG. 4 is a drawing illustrating the installation positions of the beacon modules;

FIG. 5 is a table illustrating the relationship between the installation positions of the beacon modules and the corresponding characteristic behaviors (actions) of users;

FIGS. 6A through 6C are drawings illustrating respective transmission timings of searching signals;

FIG. 7 is a drawing illustrating an example of layout data stored in a storage device of the mobile terminal;

FIG. 8 is an example table illustrating relationships between the behaviors to be stored in the storage device of the mobile terminal and corresponding access codes;

FIG. 9 is an example table illustrating relationships between the behaviors to be stored in the storage device of the mobile terminal and corresponding threshold values;

FIG. 10 is a drawing illustrating an example sensor signal of a sensor of the mobile terminal;

FIG. 11 is a flowchart illustrating a flow of an action state determination process performed by an action state determination section;

FIG. 12 is a flowchart illustrating a flow of a beacon search process and a positional information derivation process performed by a beacon search section and a positional information derivation section, respectively;

FIG. 13 is a drawing schematically illustrating a configuration capable of deriving the positional information based on communication with the beacon module; and

FIG. 14 is a drawing schematically illustrating actual accessible ranges of signals transmitted from the beacon modules.

### BEST MODE FOR CARRYING OUT THE INVENTION

In the following, embodiments of the present invention are described with reference to the accompanying drawings. In the description and the drawings, the same reference numerals are used to describe the same functional elements, and repeated descriptions thereof may be omitted.

### First Embodiment

### 1. Description of a Positioning System

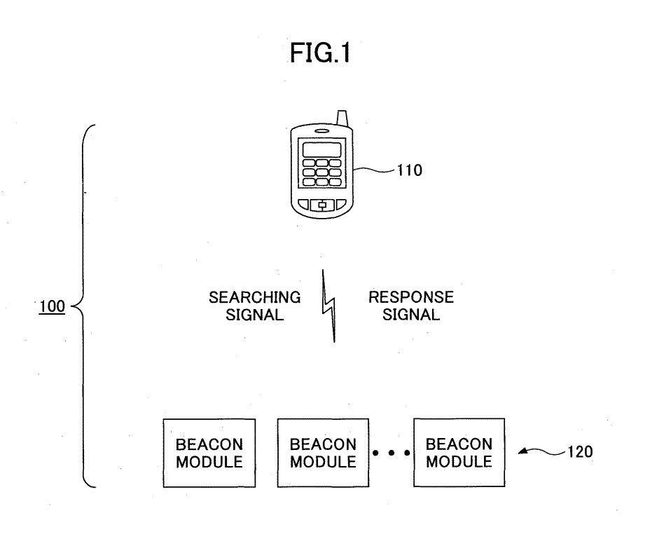

First, an overall configuration of a positioning system according to this embodiment is described. FIG. 1 illustration an overall configuration of a positioning system 100 according to this embodiment.

As illustrated in FIG. 1, the positioning system 100 includes a mobile terminal (communication device) 110 and plural beacon modules 120.

The mobile terminal 110 is carried by a user while being attached to the user. The mobile terminal 110 includes sensors to be used for determining the user's action (behavior) state.

Further, it is assumed that a positioning application (details thereof are described below) has been installed into the mobile terminal 110. Based on the positioning application, action state data, which are to be used for determining the user's action state based on sensor signals detected by the sensors mounted in the mobile terminal 110, are calculated, and when the calculated action state data satisfies a predetermined condition, a searching signal is broadcast transmitted.

Further, when a response signal is transmitted from the beacon module 120 in response to the broadcast transmitted searching signal, the response signal is received by the mobile terminal 110. Further, based on the information included in the received response signal, the mobile terminal 110 derives the positional information of the current position of the user who carries the mobile terminal 110. Further, the mobile terminal 110 notifies the user of the derived positional information.

The beacon modules 120 are installed at predetermined indoor locations (such as, for example, (in the middle of) a walkway where there is no branching, a T-junction, a crossroad, a staircase landing, inside an elevator, a walkway in front of an elevator, in a room, near a counter (reception desk), etc.).

When the beacon module 120 receives the searching signal in accordance with the installation position thereof from the mobile terminal 110, the beacon module 120 transmits the response signal. In this case, it is assumed that the response signal includes the information indicating the installation position of the beacon module 120.

Further, in this embodiment, it is also assumed that the communications between the mobile terminal 110 and the beacon module 120 are wirelessly performed using the Bluetooth (registered trademark).

### 2. Description of the Mobile Terminal

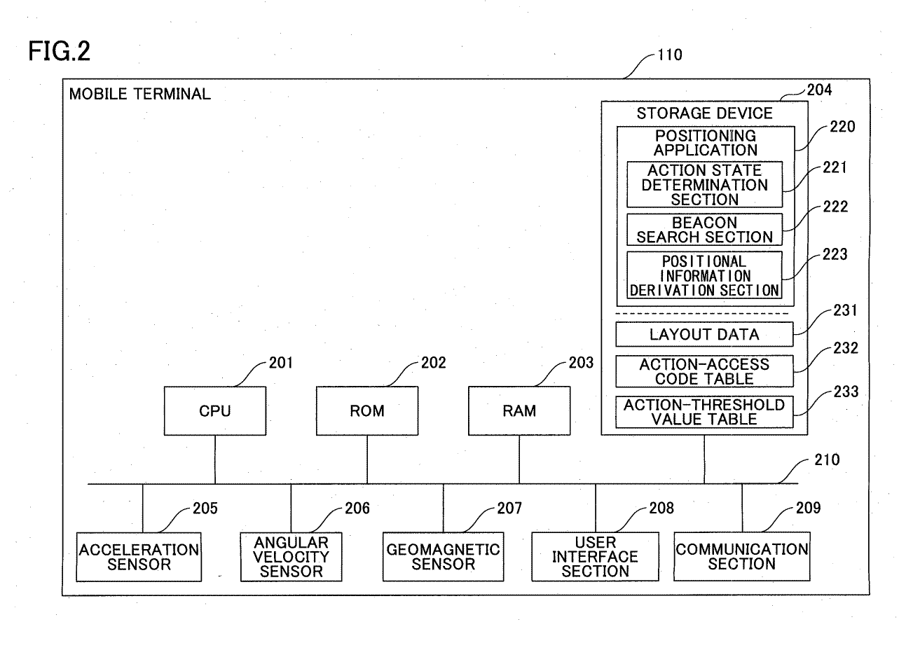

Next, a hardware configuration of the mobile terminal 110 included in the positioning system 100 is described. FIG. 2 illustrates a hardware configuration of the mobile terminal 110.

As illustrated in FIG. 2, the mobile terminal 110 includes a Central Processing Unit (CPU) 201, a Read-Only Memory (ROM) 202, a Random Access Memory (RAM) 203, and a storage device 204. The mobile terminal 110 further includes an acceleration sensor 205, an angular velocity sensor 206, a geomagnetic sensor 207, a user interface section 208, and a communication section 209. It is assumed that those elements are connected to each other via a bus 210.

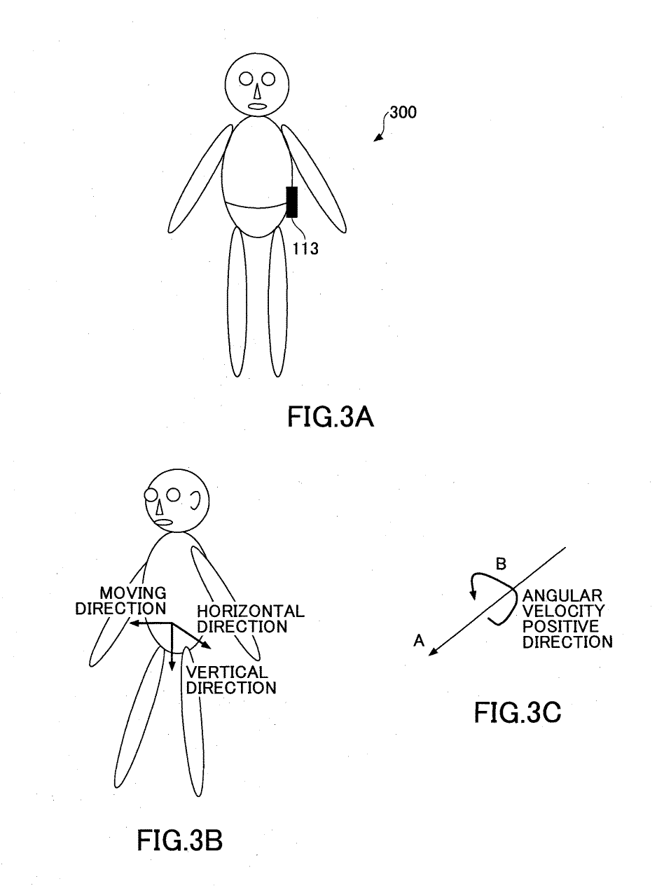

As illustrated in FIG. 3A, the mobile terminal 110 is carried by a user 300 by, for example, being attached to the body (waist part) of the user 300. Note that FIG. 3 illustrates only one example how the mobile terminal 110 is carried by the user 300. It is needless to say that as long as the mobile terminal 110 is carried by the user 300, the position where the mobile terminal 110 is attached to the body of the user 300 is not limited to the waist part.

Referring back to the description of FIG. 2, the CPU 201 is a computer (processor) that executes the positioning application 220 stored in the storage device 204. The positioning application 220 includes an action state determination section 221, a beacon search section 222, and a positional information derivation section 223. By the execution of the positioning application 220 by the CPU 201, the action state determination section 221 determines whether the user is in a walking state. Further, the action state determination section 221 calculates the action state data that is used for determining the action state of the user, so that based on the calculated action state data, the action state determination section 221 determines the action state such as, for example, the user is walking straight, the user is temporarily stopping, the user is turning to the left or right, etc. It is assumed that the calculation of the action state data is performed periodically (e.g., every one second).

The beacon search section 222 broadcast transmits the searching signal that is to be used so that the beacon module 120 in accordance with the determination result in the action state determination section 221 can be selectively searched for. Further, when the response signal is received from the beacon module 120 in response to the broadcast transmitted searching signal, the positional information derivation section 223 derives the positional information indicating the current position of the user, who carries the mobile terminal 110, based on the response signal. Further, the positional information derivation section 223 notifies the user of the derived positional information via the user interface section 208.

The ROM 202 is a non-volatile memory. The ROM 202 stores various programs and data that are necessary for the CPU 201 to execute the positioning application 220 stored in the storage device 204. Specifically, the ROM 202 stores a boot program, etc., such as, for example, a Basic Input/Output System (BIOS) and Extensible Firmware Interface (EFI).

The RAM 203 is a main memory such as a Dynamic Random Access Memory (DRAM), a Static Random Access Memory (SRAM) or the like. The RAM 203 serves as a working area which is developed (loaded) when the positioning application 220 stored in the storage device 204 is executed by the CPU 201.

The storage device 204 stores not only the positioning application 220 but also layout data 231, which indicates the office layout, to be used when the positional information is derived. The storage device 204 further stores an action-access code table 232 and an action-threshold value table 233. The action-access code table 232 indicates a relationship between the user's action state and the access code that is to be included in the searching signal. The action-threshold value table 233 is used when the user's action state is determined. Details of the layout data 231, the action-access code table 232, and the action-threshold value table 233 are described below.

The acceleration sensor 205 detects the acceleration of the user 300 who carries the mobile terminal 110, and outputs a signal indicating the acceleration vector as the sensor signal thereof. The angular velocity sensor 206 detects the angular velocity of the user 300, and outputs a signal indicating the angular velocity vector as the sensor signal thereof. The geomagnetic sensor 207 detects the magnetic direction of the user 300, and outputs a signal indicating the magnetic direction vector as the sensor signal thereof.

Here, the detection directions of the sensors in the mobile terminal 110 are described. FIGS. 3B and 3C illustrate the detection directions in which the sensors in the mobile terminal 110 detect. Specifically, FIG. 3B illustrates the directions in which the acceleration sensor 205 and the geomagnetic sensor 207 detect. Namely, as illustrated in FIG. 3B, the acceleration sensor 205 and the geomagnetic sensor 207 detect the acceleration components and the magnetic direction components, respectively, in the moving direction, the vertical direction, and the horizontal direction.

In FIG. 3C, the vector A indicates the angular velocity vector which is detected by the angular velocity sensor 206. Here, the arrow B indicates the positive direction of the angular velocity.

In this embodiment, the projections of the angular velocity vector A in the moving direction, the vertical direction, and the horizontal direction are considered to be referred to as the “angular velocity component in the moving direction”, the “angular velocity component in the vertical direction”, and the “angular velocity component in the horizontal direction”, respectively.

Referring back to the description of FIG. 2, the user interface section 208 includes a screen to input various instructions into the mobile terminal 110 and display an inner state of the mobile terminal 110. The user interface section 208 further includes various operation buttons.

The communication section 209 broadcast transmits the searching signal and receives the response signal from the beacon module 120 under control of the positioning application 220.

### 3. Description of the Beacon Module 120

Next, the beacon module 120 included in the positioning system 100 is described.

### 3.1 Installation Position of the Beacon Module 120

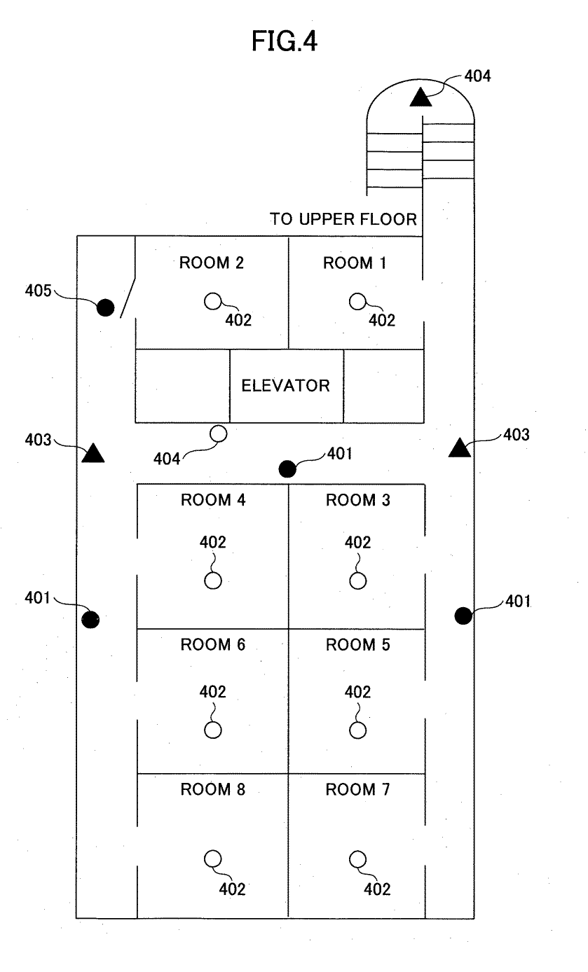

First, indoor installation positions of the beacon modules 120 are described. FIG. 4 illustrates the indoor installation positions of the beacon modules 120. As described above, the beacon module 120 is installed in order to derive the positional information of a user (that is, the beacon module 120 is installed at the position where the positional information of the user is to be derived).

As the position where the positional information of the user is to be derived, there are (a) a position where it is sufficient if the positional information of the user can be acquired; and (b) a position where the acquisition of the highly-accurate positional information of the user is desired to be used so that the user's positional information can be used for controlling a process of another system. As an example of the “process of another system”, there is a process of reporting the direction in which the user should move when the user's positional information is used for a navigation system. As another example of the “process of another system”, there is a process of changing the direction or the size of displayed layout data or changing the displayed layout data to other layout data.

In indoor, among the positions where the user's positional information thereof is to be derived, the positions which belong to the above “(a)” position include, for example,:

a walkway where there is no branching;

inside a room; etc.

Further, in indoor, among the positions where the user's positional information thereof is to be derived, the positions which belong to the above “(b)” position include, for example,:

branching position of a walkway such as where there is no branching such as a T-junction, a crossroad, etc.;

a boundary position of a floor such as stairs, an elevator, etc.;

a position where a user takes an action such as, for example, an entrance of a room, a counter (reception table); etc.

As illustrated in FIG. 4, the beacon modules 401 are installed on the respective walkways where there is no nearby branching, and the beacon modules 402 are installed in the respective rooms.

Further, the beacon modules 403 are installed at the respective branching positions of the walkways, and the beacon modules 404 are installed at the respective boundary positions of the floor. Further, the beacon module 405 is installed at the position where the user may take any action (e.g., opening/closing a door).

### 3.2 Relationship Between Installation Positions of Beacon Modules and User's Actions

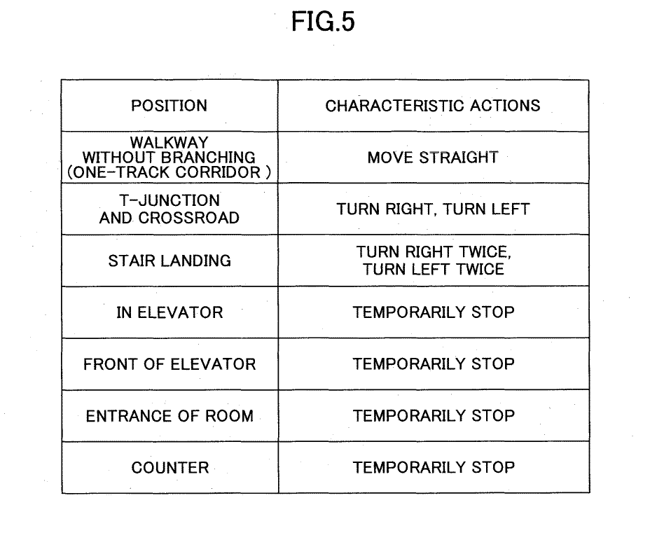

Next, the relationship between the installation positions of the beacon modules and the user's actions (behaviors) is described. At the installation positions of the beacon modules described with reference with FIG. 4, a user takes the respective characteristic actions. FIG. 5 is a table illustrating the relationship between the installation positions of the beacon modules and the respective actions that a user may take.

As illustrated in FIG. 5, a user takes action to “walk straight” at the walkway where there is no nearby branching. Further, the user takes action to “turn to the left” or “turn to the right” at the branching position of the walkway such as a T-junction, a crossroad, etc. Further, the user takes action to “turn to the left” or “turn to the right” more than once at a staircase landing which is a boundary position of the floor. Further, the user takes action to “temporarily stop” at the position in an elevator, at a walkway in front of an elevator, at an entrance of a room, at a counter, etc.

In other words, it is possible to say that the timings when the user takes the actions are the timing when the user is at the corresponding installation positions of the beacon modules. Therefore, in the positioning application 220 according to this embodiment, the searching signal is broadcast transmitted at the timings when the user takes the actions and the response signal from the beacon module is received.

As described above, by associating the timings when the searching signal is broadcast transmitted with the user's actions, it becomes possible to receive the response signal from the beacon module 120 at more appropriate timings. Namely, it becomes possible to receive the information indicating the installation position of a beacon module 120 at the installation position of the beacon module 120. Accordingly, it becomes possible to improve the accuracy of the user's positional information derived from the communications with the beacon module 120.

### 3.3 Description of the Relationship Between the Installation Position of the Beacon Module and the Transmission Timing of the Searching Signal

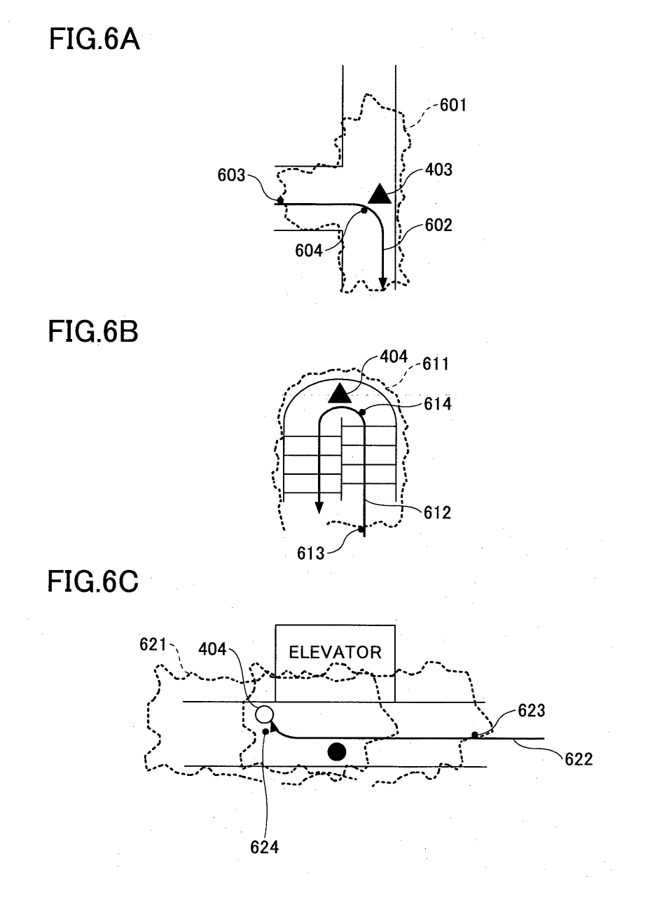

Next, the transmission timings of the searching signal by the positioning application 220 are described in more detail. FIGS. 6A through 6C illustrates the transmission timings of the searching signal by the positioning application 220 in detail.

Among the figures, FIG. 6A illustrates a transmission timing of the searching signal when the beacon module 403 is installed at the T-junction. As illustrated in FIG. 6A, the response signal transmitted from the beacon module 403 reaches in an area of a range 601. Therefore, when it is assumed that the user takes action to walk as illustrated in the arrow (direction) 602, if the searching signal is conventionally broadcast transmitted at an arbitrary timing, the mobile terminal 110 receives the response signal from the beacon module 403 at the position 603. Namely, a conventional mobile terminal recognizes that the user passes through the T-junction in a state that the user is at the position 603 which is separated from the T-junction.

On the other hand, like this embodiment, when the searching signal is arranged to be broadcast transmitted at the timing when the user takes the action to turn to the right, the mobile terminal 110 receives a response signal from the beacon module 403 at the position 604. Namely, according to the positioning application 220 in this embodiment, it becomes possible to recognize that the user passes through the T-junction when the user is at the position 604 of the T-junction. As a result, it becomes possible to improve the accuracy of the derived positional information.

Similarly, FIG. 6B illustrates a transmission timing of the searching signal when the beacon module 404 is installed at the staircase landing. As illustrated in FIG. 6B, the response signal transmitted from the beacon module 404 reaches in an area of a range 611. Therefore, when it is assumed that the user takes action to walk as illustrated in the arrow 612, if the searching signal is conventionally broadcast transmitted at an arbitrary timing, the mobile terminal 110 receives the response signal from the beacon module 404 at the position 613. Namely, a conventional mobile terminal recognizes that the user passes through the staircase landing in a state that the user is at the position 613 which is separated from the staircase landing.

On the other hand, like this embodiment, when the searching signal is arranged to be broadcast transmitted at the timing when the user takes the action to turn to the left, the mobile terminal 110 receives a response signal from the beacon module 404 at the position 614. Namely, according to the positioning application 220 in this embodiment, it becomes possible to recognize that the user passes through the staircase landing when the user is at the position 614 of the staircase landing. As a result, it becomes possible to improve the accuracy of the derived positional information.

Similarly, FIG. 6C illustrates a transmission timing of the searching signal when the beacon module 404 is installed in front of the elevator. As illustrated in FIG. 6C, the response signal transmitted from the beacon module 404 reaches in an area of a range 621. Therefore, when it is assumed that the user takes action to walk as illustrated in the arrow (direction) 622, if the searching signal is conventionally broadcast transmitted at an arbitrary timing, the mobile terminal 110 receives the response signal from the beacon module 404 at the position 623. Namely, a conventional mobile terminal recognizes that the user is in front of the elevator in a state that the user is at the position 623 which is separated from the front of the elevator.

On the other hand, like this embodiment, when the searching signal is arranged to be broadcast transmitted at the timing when the user takes the action to temporarily stop, the mobile terminal 110 receives response signal from the beacon module 404 at the position 624. Namely, according to the positioning application 220 in this embodiment, it becomes possible to recognize that the user reaches the front of the elevator when the user is at the position 624 which is in front of the elevator. As a result, it becomes possible to improve the accuracy of the derived positional information.

### 4. Detailed Description of the Mobile Terminal

Next, details of the mobile terminal 110 are described.

### 4.1 Description of Data Stored in the Storage Device

First, details are described of the layout data 231, the action-access code table 232, and the action-threshold value table 233 that are stored in the storage device 204 of the mobile terminal 110.

### (1) Layout Data 231

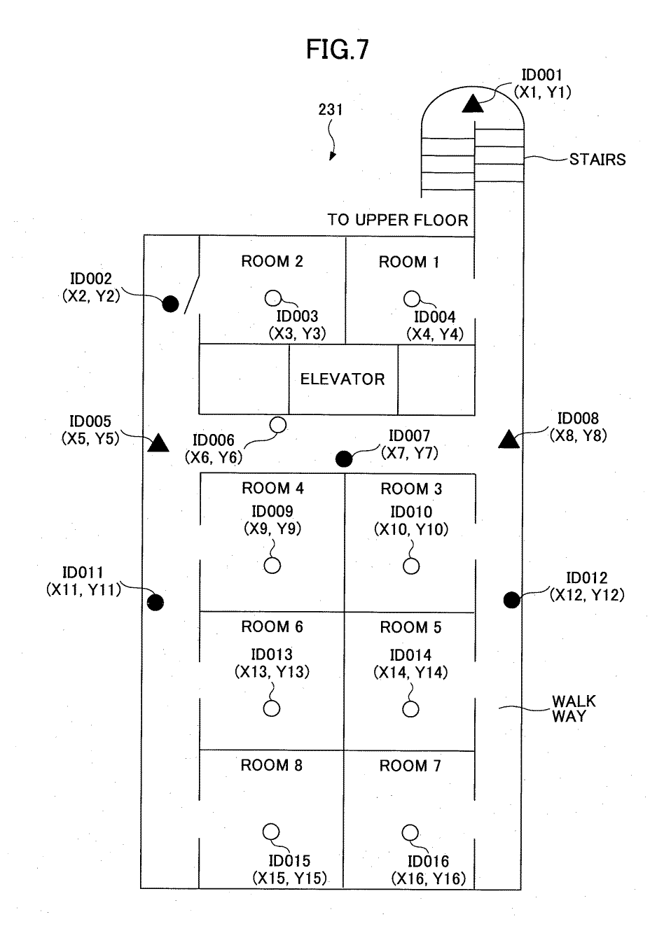

FIG. 7 illustrates an example of the layout data 231 stored in the storage device 204 of the mobile terminal 110. As illustrated in FIG. 7, the layout data 231 describes the positions and the sizes of the walkways, the stairway, the rooms, the elevator, etc., in the office. Further, the layout data 231 describes the beacon modules that are installed at the walkways, the staircase landing, the entrance of the room, the room, the elevator, etc. The beacon modules have the respective identification numbers which are provided to identify the beacon modules, so that the identification numbers are registered in association with the information (coordinates) which indicates the installation positions of the beacon modules.

### (2) Action-Access Code Table 232

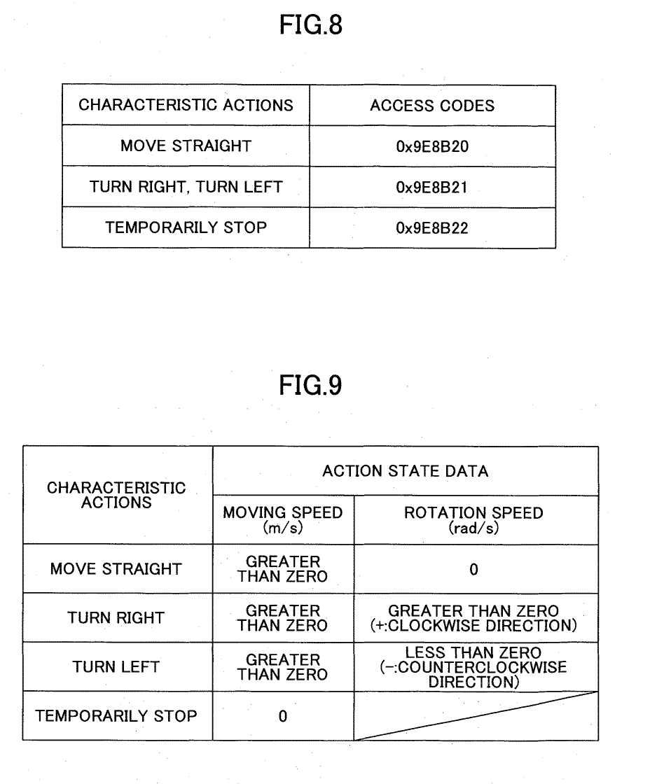

FIG. 8 illustrates an example of the action-access code table 232 stored in the storage device 204 of the mobile terminal 110. As illustrated in FIG. 8, in the action-access code table 232, the characteristic actions and the corresponding access codes are registered.

According to the specifications of Bluetooth (registered trademark), it is possible to input a three-byte access code in the searching signal. In general-purpose devices, the data “0x9E8B33” are set as the access code. Therefore, in the positioning system 100 according to this embodiment, an access code other than “0x9E8B33” is included and transmitted in the searching signal.

As described above, by including different access codes corresponding to the characteristic actions into the searching signal and broadcast transmitting the searching signal, it becomes possible for the mobile terminal 110 to communicate with only an appropriate beacon module only. Therefore, the accessible range of the transmitted response signal changes. Accordingly, it becomes possible for the mobile terminal 110 to receive only the response signal from the appropriate beacon module even when the boundary between (the actual accessible ranges of) the beacon modules adjacent to each other becomes uncertain (indecisive).

As a result, it becomes possible to improve the accuracy of the positional information derived based on the communications with the beacon modules.

Further, the access codes in association with the characteristic actions may be registered as the default values in advance, or may be registered when the beacon modules 120 are installed.

### (3) Action-Threshold Value Table 233

FIG. 9 illustrates an example of the action-threshold value table 233 stored in the storage device 204 of the mobile terminal 110. The action-threshold value table 233 is used when the user's action state is determined based on the calculated action state data. As illustrated in FIG. 9, in the action-threshold value table 233, the characteristic actions and the corresponding threshold values for determining that the characteristic actions are performed based on the action state data. The action state data include moving speed and rotation speed, and the respective threshold values are set for the moving speed and the rotation speed.

For example, when the moving speed is greater than zero and the rotation speed is zero (0 rad/s) as the action state data, it is determined that the user is in a “straight-moving action”. Further, when the moving speed is greater than zero and the rotation speed is greater than zero as the action state data, it is determined that the user is in a “right-turning action”.

Further, when the moving speed is greater than zero and the rotation speed is less than zero (i.e., a minus value) as the action state data, it is determined that the user is in a “left-turning action”. Further, when the moving speed is zero, it is determined that the user is in a “temporarily-stopping action”.

### 4.2 Description of a Process Performed by the Action State Determination Section 221

Next, a process of calculating the action state data performed by the action state determination section 221 is described.

### (1) Method of Determining the Walking State Performed by the Action State Determination Section 221

First, a method of determining the walking state performed by the action state determination section 221 of the mobile terminal 110 is described.

First, in order to calculate the action state data, the action state determination section 221 determines whether the user is in the walking state. Specifically, first, a gravity acceleration vector is acquired based on the acceleration vector received from the acceleration sensor 205 and the angular velocity vector received from the angular velocity sensor 206. Then, by subtracting the gravity acceleration vector from the acceleration vector, the time series data of a residual acceleration component are obtained. After that, a main component analysis is performed on the time series data of a residual acceleration component, so that the moving direction in the walking state is acquired.

Further, a pair of a top peak and a bottom peak of the acceleration component in the vertical direction is searched for, and a pair of a bottom peak and a top peak of the acceleration component in the horizontal direction is searched for. Further, a gradient of the acceleration component in the moving direction is calculated. Then, it is determined whether the gradient of the acceleration component in the moving direction at the detection time detecting the bottom peak when the top peak is changed into the bottom peak of the acceleration component in the vertical direction is greater than or equal to a predetermined value. When it is determined that the gradient is greater than or equal to the predetermined value, it is determined that the user is in the walking state.

### (2) Method of Calculating the Action State Data Performed by the Action State Determination Section 221

Next, a method is described of calculating the action state data performed by the action state determination section 221 of the mobile terminal 110. As the action state data, the action state determination section 221 calculates the moving speed (m/s) and the rotation speed (rad/s) in the walking action.

First, a method is described of calculating the moving speed in the walking action of the user. The action state determination section 221 acquires the gravity acceleration vector based on the acceleration vector and the angular velocity vector. Then, based on the gravity acceleration vector and the acceleration vector, the action state determination section 221 calculates the acceleration vector that is generated by the walking action. Further, based on the acceleration vector in the moving direction in the walking action, the action state determination section 221 calculates the moving speed in the walking action.

Next, a method is described of calculating the rotation speed in the walking action of the user. The action state determination section 221 determines the direction of the user's body based on the angular velocity vector received from the angular velocity sensor 206. Then, the action state determination section 221 calculates the rotation speed (rad/s) by calculating the time before and after the case of determining that the direction of the user's body has changed.

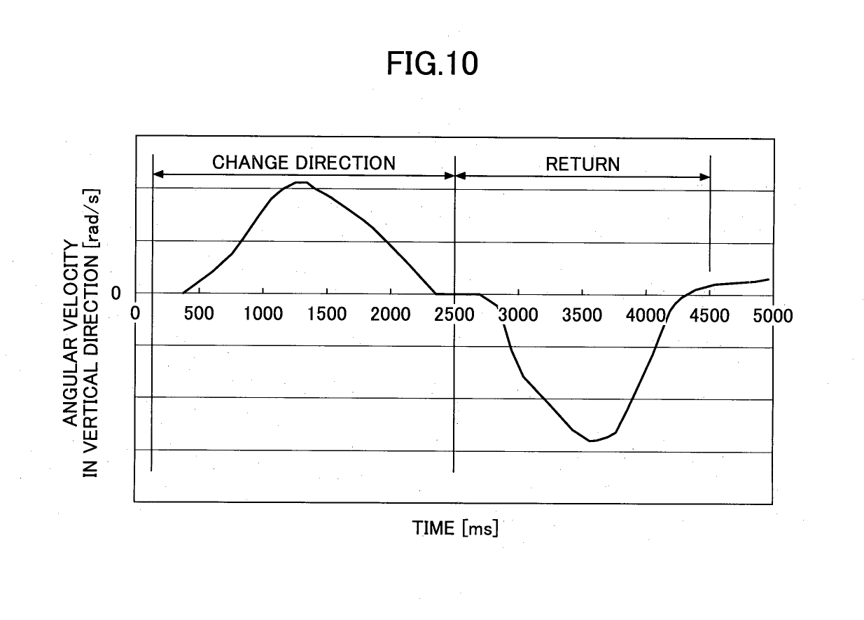

FIG. 10 is a drawing illustrating a waveform of the angular velocity component in the vertical direction when the direction of a user's body is changed by 90 degrees while the user is in a stopping state. Here, a positive value of the angular velocity component in the vertical direction indicates the action of changing the body in the right direction. On the other hand, a negative value of the angular velocity component in the vertical direction indicates the action of changing the body in the left direction.

When the change over time of the angular velocity component in the vertical direction of the angular velocity vector received from the angular velocity sensor 206 indicates that, as illustrated in FIG. 10, it starts from zero and gradually increases to the top peak and then returns back to zero and the time of this period is approximately 3 seconds, it is determined that the action is that the direction of the body has been changed to the right.

On the other hand, when the change over time of the angular velocity component in the vertical direction indicates that, as illustrated in FIG. 10, it starts from zero and gradually decreases to the bottom peak and then returns back to zero and the time of this period is approximately 1.5 seconds, it is determined that the action is that the direction of the body has been changed to the left.

Then, the rotation speed is calculated based on the angular difference between before and after the change and the time necessary for the change when it is determined that the direction of the body has been changed to the right. Similarly, the rotation speed is calculated based on the angular difference between before and after the change and the time necessary for the change when it is determined that the direction of the body has been changed to the left. As described above, both the moving speed and the rotation speed are calculated.

### (3) Flow of Action State Determination Process Performed by the Action State Determination Section 221

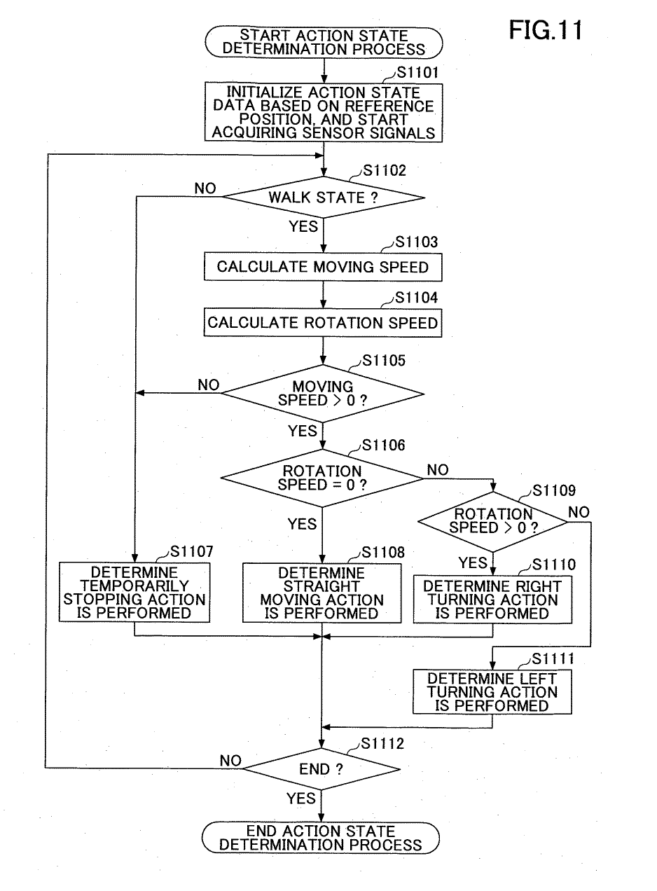

Next, a flow of an action state determination process performed by the action state determination section 221 of the mobile terminal 110 is described. FIG. 11 is a flowchart of the action state determination process performed by the action state determination section 221. When the positioning application 220 is started up in the mobile terminal 110, the action state determination process of FIG. 11 is executed.

In step S1101, based on a predetermined reference position, the action state data of the mobile terminal 110, which becomes the target of this process, are initialized. When the initialization is finished, the action state determination section 221 starts receiving the sensor signals of the mobile terminal 110.

In step S1102, based on the received sensor signals, it is determined whether the user who is carrying the mobile terminal 110 is in the walking state. When it is determined that the user is in the walking state, the process goes to step S1103, where the moving speed is calculated. Further, in step S1104, the rotation speed is calculated.

In step S1105, it is determined whether the calculated moving speed is greater than zero. When the moving speed is determined to be zero in step S1105 or when it is determined that the user is not in the walking state in step S1102, the process goes to step S1107, where it is determined that the temporarily-stopping action is performed.

On the other hand, when it is determined that the moving speed is greater than zero in step S1105, the process goes to step S1106, where it is further determined whether the calculated rotation speed is zero. When determining that the rotation speed is zero in step S1106, the process goes to step S1108, where it is determined that the straight-moving action is performed.

On the other hand, when it is determined that the rotation speed is not zero, the process goes to step S1109, where it is further determined whether the rotation speed is greater than zero. When it is determined that the rotation speed is greater than zero, the process goes to step S1110, where it is determined that the right-turning action is performed.

On the other hand, when it is determined that the rotation speed is less than zero, the process goes to step S1111, where it is determined that the left-turning action is performed.

In step S1112, it is determined whether the action state determination process is to be finished. When the positioning application 220 continues, the process goes back to step S1102. On the other hand, when the termination of the positioning application 220 is instructed, the action state determination process is finished.

### 4.3 Description of Processes Performed by the Beacon Search Section 222 and the Positional Information Derivation Section 223

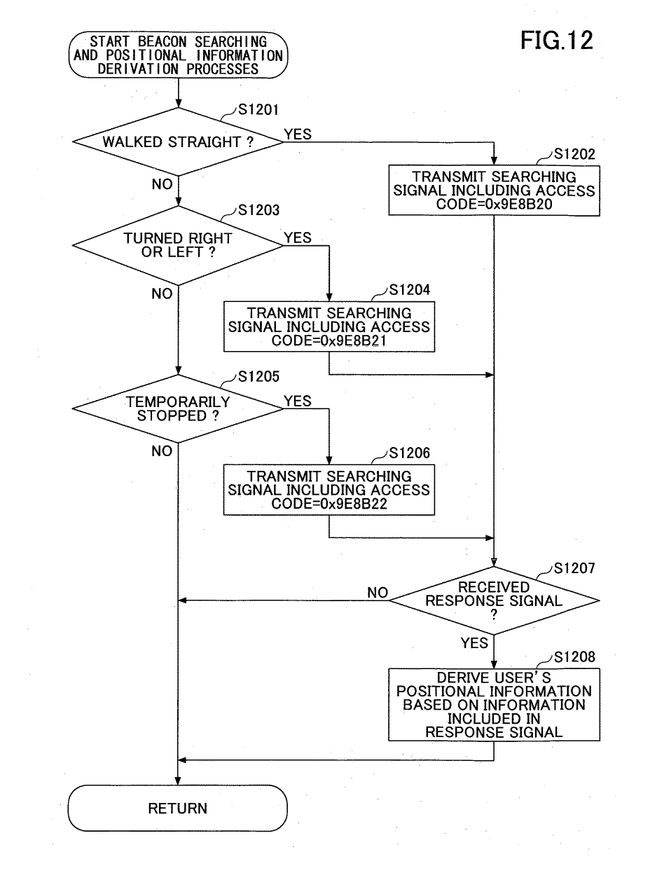

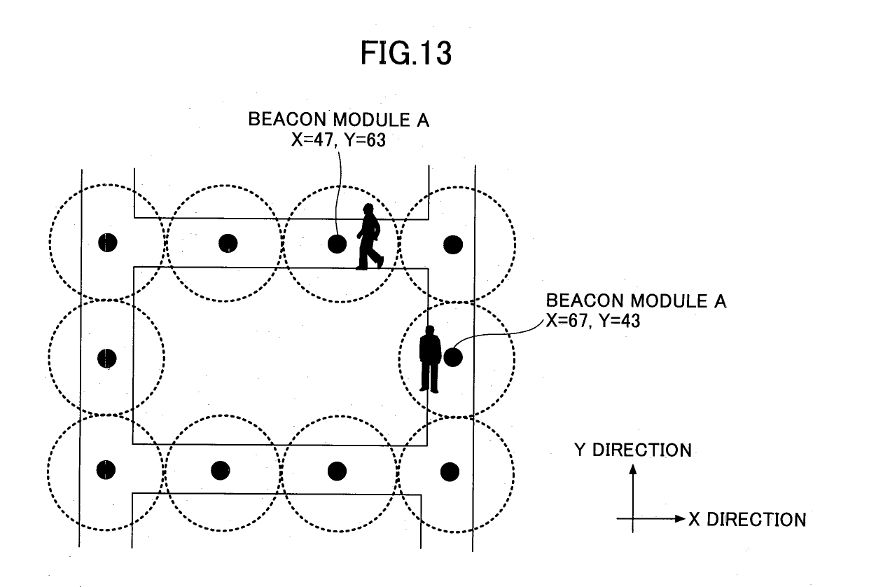

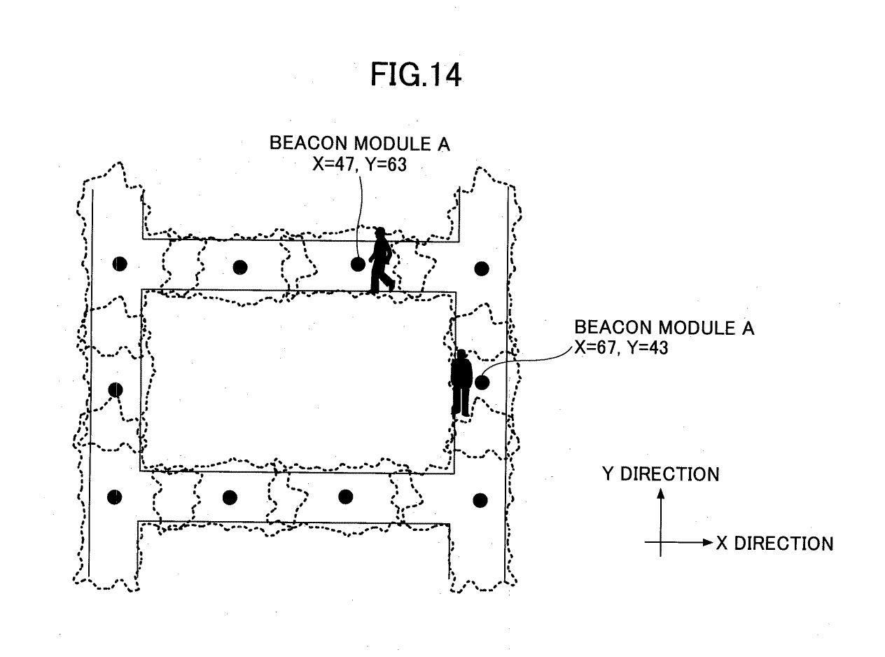

Next, a flow is described of the processes performed by the beacon search section 222 and the positional information derivation section 223 of the mobile terminal 110. FIG. 12 is a flowchart of beacon search and positional information derivation processes performed by the beacon search section 222 and the positional information derivation section 223 in the mobile terminal 110.

In step S1201, it is determined whether the user performs the straight-moving action based on the calculated action state data by referring to the action-threshold value table 233. When determining that the user performs the straight-moving action in step S1201, the process goes to step S1202, where the searching signal including the data “0x9E8B20” as the access code is broadcast transmitted. Namely, the beacon module 120 that responses to the searching signal including the data “0x9E8B20” as the access code is selectively searched for.

In step S1207, it is determined whether the response signal is transmitted from the beacon module 120 in response to the broadcast transmitted searching signal in step S1202. When it is determined that the response signal is not transmitted in step S1207, the process goes back to step S1201 again after a predetermined time period (cycle) (e.g., 1 second) has passed.

On the other hand, when it is determined that the response signal is transmitted in step S1207, the process goes to step S1208, where the positional information is derived indicating the current position of the user based on the information included in the received response signal and indicating the installation position of the beacon module 120. Then, after a predetermined time period (cycle) (e.g., 1 second) has passed, the process goes back to step S1201 again.

On the other hand, when it is determined that the user does not perform the straight-moving action in step S1201, the process goes to step S1203, where it is further determined whether the user performs the right-turning action or the left-turning action. When it is determined that the user performs the right-turning action or the left-turning action, the process goes to step S1204, where the searching signal including the data “0x9E8B21” as the access code is broadcast transmitted.

In step S1207, it is determined whether the response signal is transmitted from the beacon module 120 in response to the broadcast transmitted searching signal in step S1204. When it is determined that the response signal is not transmitted in step S1207, the process goes back to step S1201 again after a predetermined time period (cycle) has passed.

On the other hand, when it is determined that the response signal is transmitted in step S1207, the process goes to step S1208, where the positional information is derived indicating the current position of the user based on the information included in the received response signal and indicating the installation position of the beacon module 120. Then, after a predetermined time period (cycle) has passed, the process goes back to step S1201 again.

On the other hand, when it is not determined that user performs the right-turning action or the left-turning action in step S1203, the process goes to step S1205, where it is further determined whether the user performs the temporarily-stopping action. When it is determined that the user performs the temporarily-stopping action in step S1205, the process goes to step S1206, where the searching signal including the data “0x9E8B22” as the access code is broadcast transmitted.

In step S1207, it is determined whether the response signal is transmitted from the beacon module 120 in response to the broadcast transmitted searching signal in step S1205. When it is determined that the response signal is not transmitted in step S1207, the process goes back to step S1201 again after a predetermined time period (cycle) has passed.

On the other hand, when it is determined that the response signal is transmitted in step S1207, the process goes to step S1208, where the positional information is derived indicating the current position of the user based on the information included in the received response signal and indicating the installation position of the beacon module 120. Then, after a predetermined time period (cycle) has passed, the process goes back to step S1201 again.

### 5. Summary

As apparent from the above descriptions, the positioning system 100 according to this embodiment includes the following features:

an autonomy navigation means is provided in the mobile terminal and the action state data are calculated at a predetermined cycle, so that the action state of the user who carries the mobile terminal is monitored in real-time;

whether the characteristic action such as the “straight-moving action”, the “right-turning action” , the “left-turning action”, the “temporarily-stopping action”, etc., is performed by the user is determined based on the calculated action state data;

the access codes corresponding to the characteristic actions are determined, so that when the characteristic actions are performed, the corresponding access codes are included in the searching signal and broadcast transmitted;

the beacon modules are installed where the characteristic actions are (likely to be) performed, so that only when the searching signal including the access code corresponding to the characteristic action is received, the response signal is transmitted to the mobile terminal that transmitted the searching signal; and

when receiving the response signal including the information indicating the installation position of the beacon module, the mobile terminal determines that there is the user carrying the mobile terminal at the installation position of the beacon module.

As described above, by associating the transmission timing and the transmission content of the searching signal with the user's actions, it become possible, to receive the response signal at more appropriate timing from an appropriate beacon module. Namely, it becomes possible to receive the information indicating the installation position of the beacon module, so that it become possible to improve the accuracy of the positional information of the user derived based on the communication with the beacon module.

### Second Embodiment

In the above first embodiment, the response signal, which is transmitted from the beacon module 120, includes the information indicating the installation position of the beacon module 120, so that based on the information, the positioning application 220 derives the positional information indicating the current position of the user. However, the present invention is not limited to this configuration. The identification information of the beacon module 120 (identifying the beacon module 120) may be included in the response signal transmitted from the beacon module 120.

In this case, the positional information derivation section 223 of the positioning application 220 acquires the information indicating the installation position of the beacon module 120 corresponding to the identification information of the beacon module 120 by referring to the layout data 231. By doing this, it becomes possible to derive the positional information indicating the current position of the user.

Further, in the above first embodiment, the mobile terminal 110 is equipped with the acceleration sensor 205, the angular velocity sensor 206, and the geomagnetic sensor 207, so that the autonomy navigation means is formed by calculating the user's action state data based on the sensor signals from the sensors. However, the present invention is not limited to this configuration. The autonomy navigation means may be formed by calculating the action state data based on a sensor signal from another sensor.

Further, in the above first embodiment, the radio field intensity of the searching signal is not clearly described that is broadcast transmitted when it is determined that a characteristic action is performed. However, for example, the broadcast transmission may be performed with different radio field intensity depending on the characteristic actions. More specifically, the radio field intensity of the searching signal to be broadcast transmitted may differ in the order: the “straight-moving action” >the “right-turning action” and the “left-turning action” >the “temporarily-stopping action”.

In the above first embodiment, Bluetooth (registered trademark) is used as the communication method between the mobile terminal 110 and the beacon module 120. However, the present invention is not limited to this configuration. Another communication method may alternatively be used.

In the above first embodiment, as the characteristic actions, the four actions, that is, the “straight-moving action”, the “right-turning action”, the “left-turning action”, and the “temporarily-stopping action”, are registered. However, the present invention is not limited to this configuration. Another characteristic action may be registered.

In the above first embodiment, as the installation positions of the beacon modules, the “walkway where there is no branching”, the “T-junction and the crossroad”, the “staircase landing”, the “inside an elevator” and “in front of an elevator”, “in a room”, “near a counter”, etc., are described. However, the beacon module may be installed at another position where the characteristic action is performed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teachings herein set forth.

The present application is based on and claims the benefit of priority of Japanese Patent Application No. 2013-265735 filed Dec. 24, 2013, the entire contents of which are hereby incorporated herein by reference.

### DESCRIPTION OF THE REFERENCE NUMERALS

100: POSITIONING SYSTEM
110: MOBILE TERMINAL 110
120: BEACON MODULE 120
130: PC
140: NETWORK
201: CPU
202: ROM
203: RAM
204: STORAGE DEVICE
205: ACCELERATION SENSOR
206: ANGULAR VELOCITY SENSOR
207: GEOMAGNETIC SENSOR
208: USER INTERFACE SECTION
209: COMMUNICATION SECTION
220: POSITIONING APPLICATION
221: ACTION STATE DETERMINATION SECTION
222: BEACON SEARCH SECTION
223: POSITIONAL INFORMATION DERIVATION SECTION
231: LAYOUT DATA
232: ACTION-ACCESS CODE TABLE
233: ACTION-THRESHOLD VALUE TABLE

### PRIOR ART DOCUMENTS

### Patent Document

[Patent Document 1] Japanese Patent No. 4199290
[Patent Document 2] Japanese Patent No. 4865031

1. A positioning system, comprising:
a plurality of beacon modules; and
a communication device,
wherein the communication device includes
a processor, and
a memory storing a program that, when executed by the processor, causes the communication device to
calculate action state data that are used for determining an action state of a user carrying the communication device,
selectively search for one of the beacon modules in accordance with the action state of the user, determined based on the calculated action state data, by transmitting a searching signal that includes an access code in accordance with the determined action state of the user, and
derive positional information of the user based on a response signal transmitted from the one of the beacon modules that receives the searching signal.

2. The positioning system according to claim 1,
wherein the communication device is caused to selectively search for the one of the beacon modules at a timing when the action state data satisfy a predetermined condition.

3. The positioning system according to claim 1,
wherein the action state data include moving speed and rotation speed when the user is walking.

4. (canceled)

5. The positioning system according to claim 1,
wherein the communication device is caused to transmit the searching signal having radio field intensity that differs depending on the action state of the user determined based on the action state data.

6. The positioning system according to claim 5,
wherein the one of the beacon modules transmits the response signal to the communication device upon receiving the searching signal including the access code, the access code being in accordance with an installation position of the one of the beacon modules.

7. The positioning system according to claim 6,
wherein the one of the beacon modules is installed at a position where it is determined that the action state data satisfy a predetermined condition.

8. The positioning system according to claim 7,
wherein the one of the beacon modules is installed in a walkway where there is no branching, at a branching position of a walkway, at a staircase landing, in an elevator, in front of an elevator, at an entrance of a room, or in front of a reception desk.

9. A non-transitory computer-readable storage medium having stored therein a program for causing a computer of a communication device in configured to communicate with a plurality of beacon modules to execute a process, the process comprising:
calculating action state data that are used for determining an action state of a user carrying the communication device,
selectively searching for one of the beacon modules in accordance with the action state of the user, determined based on the calculated action state data, by transmitting a searching signal that includes an access code in accordance with the determined action state of the user, and
deriving positional information of the user based on a response signal transmitted from the one of the beacon modules that receives the searching signal.

10. The non-transitory computer-readable storage medium according to claim 9,
wherein, in said searching, the communication device selectively searches for the one of the beacon modules at a timing when the action state data satisfy a predetermined condition.

11. The non-transitory computer-readable storage medium according to claim 10,
wherein, in said searching, the communication device determines whether the predetermined condition is satisfied based on moving speed and rotation speed that are included in the action state data.

12. The non-transitory computer-readable storage medium according to claim 11,
wherein, in said searching, the communication device transmits a searching signal having radio field intensity that differs depending on the moving speed and the rotation speed.

13. (canceled)
